(19) United States
(12) Patent Application Publication
(10) Pub. No.: US 2010/0309181 A1
(43) Pub. Date: Dec. 9, 2010

(54) Integrated and Simplified Source Driver System for Displays

(76) Inventors: WAN-HSIANG SHEN, Taipei (TW); JYH-TING LAI, Taipei (TW); YUNG-TAI CHEN, Taipei (TW); TA-SHENG CHI, Taipei (TW); KAI-CHUN CHANG, Taipei (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/540,604

(22) Filed: Aug. 13, 2009

(30) Foreign Application Priority Data
Jun. 8, 2009 (TW) 098119031

(51) Int. Cl. G09G 5/00

(52) U.S. Cl. 345/208

(57) ABSTRACT

An integrated and simplified source driver system includes a scan driver and a data driver. The data driver has a signal controller and a plurality of data driver units each of which has a converter. The converter can convert a first control signal into display data, a driver-unit control signal and a second control signal. The data driver unit can correspondingly send a data drive signal to one of thin film transistors according to the display data and the driver-unit control signal. The second control signal is sent to the scan driver for generating a scan drive signal which is correspondingly sent to one of the thin film transistors. In a preferred embodiment, the first control signal includes an integrated drive-unit control command.

### BACKGROUND OF THE INVENTION

1. Field of the Invention

The present invention relates to an integrated and simplified source driver system for displays. More particularly, the present invention relates to the integrated and simplified source driver system generating a first control signal, including a control command and a data signal combined therewith, to output to a data driver.

2. Description of the Related Art

Taiwanese Patent Pub. No. I286299, entitled “SOURCE DRIVER FOR DISPLAY,” discloses a conventional display having a source driver system. Referring to FIG. 1, a schematic view of the source driver system of the display according to TWN Patent Pub. No. I286299 is disclosed. With continued reference to FIG. 1, the source driver system includes a scan driver 11 and a data driver 12 so as to control a LCD display (not shown in FIG. 1) to display images.

Still referring to FIG. 1, the scan driver 11 includes, for example, 256 scan lines (identified as G1, G2, . . . , G256), and is operated to serially scan the scan lines G1, G2, . . . , G256 so as to control a plurality of pixels of the LCD display. Each of the pixels is controlled and generated from a corresponding thin film transistor (not shown), which may be abbreviated as “TFT”. Furthermore, the scan lines G1, G2, . . . , G256 electrically connect with gates of the corresponding thin film transistors for controlling on/off operations of the corresponding gates.

Still referring to FIG. 1, the data driver 12 can send associated drive signals to the thin film transistor to control primary colors (for example: R, G, B) and brightness of the pixel, as best shown in the upper portion of FIG. 1, so that the LCD display can be operated to generate a series of predetermined images by the control of the scan driver 11 and the data driver 12.

With continued reference to FIG. 1, the data driver 12 includes a signal controller and a plurality of data driver units. The signal controller is adapted to receive signals transmitted from a computer or a signal source, and to process them by means of suitable manners. Consequently, the signal controller generates a first control signal to send to the data driver units. Each of the data driver units is operated to generate drive signals to the corresponding thin film transistor in response to the control signal, as best shown in the upper portion of FIG. 1. In addition to this, the signal controller further generates a second control signal to send to the scan driver 11, as best shown in the left side of FIG. 1.

Still referring to FIG. 1, the scan driver 11 further includes at least one or a plurality of scan driver units serially connected. The scan driver 11 is adapted to receive the second control signal transmitted from the signal controller of the data driver 12. Subsequently, each of the scan driver units of the scan driver 11 generates drive signals to output to the corresponding thin film transistors. Alternatively, the scan driver 11 can serially transmit the second control signal among the scan driver units from one lever to the next level. In this manner, the next-level scan driver unit can generate the drive signals to output to the corresponding thin film transistors according to the second control signal.

As has been discussed above, the first control signal may be composed of several signals such as CKH signal, DATA signal, STH signal, LOAD signal, and POL signal etc., wherein CKH signal is known as a pulse signal for the data driver, DATA signal is known as a data display signal for the data driver, STH signal is known as a start signal for the data driver, LOAD signal is known as a data-loading signal for the data driver, and POL signal is known as a polarity reversal signal for the data driver.

The second control signal may also be composed of several signals such as CKV signal, STV signal, and OEV signal etc., wherein CKV signal is known as a pulse signal for the scan driver, STV signal is known as a start signal for the scan driver, and OEV signal is known as an output start signal of the scan driver.

However, the data driver 12 of the source driver system provided in the conventional LCD display requires the signal controller transmitting display data and control signals to the scan driver units of the different scan driver 11 which may sophisticate the signal-processing/transmitting procedure of the entire system. In consideration of simplifying the entire system, there exists a need of providing an integrated transmit interface in the source driver system to solve the above problem.

The source driver system has been described in many Taiwanese patent application publications and issued patents, for example, including TWN patent appl. publication No. 200909914, TWN patent application Pub. No. 200907893, TWN patent application Pub. No. 200907909, TWN patent application Pub. No. 200849204, TWN patent application Pub. No. 200844946, TWN patent application Pub. No. 200832315, TWN patent application Pub. No. 200813930, TWN patent application Pub. No. 200813973, TWN patent application Pub. No. 200744039, TWN patent application Pub. No. 200727707, TWN patent application Pub. No. 200721083, TWN patent application Pub. No. 200713188, TWN patent application Pub. No. 200713189, and TWN patent application Pub. No. 200615893; and TWN patent issued Pub. No. I286299 and TWN patent issued Pub. No. I270038. Each of the above-mentioned Taiwanese patent application publications and issued patents is incorporated herein by reference for purposes including, but not limited to, indicating the background of the present invention and illustrating the state of the art.

Further, the source driver system has also been described in many U.S. patent application publications and issued patents, for example, including US20070290979, US20070063134, US20030052854, US2006279260, US2003052854, US20080030453, US20080001944, US20080001898, US20070229440, US20070182690, US20070057327, US20060152466, US20060022930, US20050270263, US20050168432, US20050162374, US20030231153, US20020175662 and US20010007135; and, U.S. Pat. No. 7,471,289, U.S. Pat. No. 7,436,381, U.S. Pat. No. 7,432,904, U.S. Pat. No. 7,425,941, U.S. Pat. No. 7,327,299, U.S. Pat. No. 7,327,297, U.S. Pat. No. 7,304,621, U.S. Pat. No. 7,292,217, U.S. Pat. No. 7,259,742, U.S. Pat. No. 7,187,421, U.S. Pat. No. 7,180,323, U.S. Pat. No. 7,050,033, U.S. Pat. No. 6,970,153, U.S. Pat. No. 6,954,192, U.S. Pat. No. 6,950,045, U.S. Pat. No. 6,831,620, U.S. Pat. No. 6,747,626, U.S. Pat. No. 6,727,880, U.S. Pat. No. 6,333,730, U.S. Pat. No. 6,075,524, U.S. Pat. No. 5,744,986, U.S. Pat. No. 7,342,567, U.S. Pat. No. 7,199,575, U.S. Pat. No. 7,180,323, U.S. Pat. No. 6,963,323, U.S. Pat. No. 6,718,478, U.S. Pat. No. 6,384,805, U.S. Pat. No. 6,335,721, U.S. Pat. No. 6,326,913 and U.S. Pat. No. 6,008,801. Each of the above-mentioned U.S. patent application publications and issued patents is incorporated herein by reference for purposes including, but not limited to, indicating the background of the present invention and illustrating the state of the art.

Yet further, the source driver system has also been described in many foreign patent application publications and issued patents, for example, including JP2008116936, JP2007299013, JP2007206454, JP2007156503, JP2004296741, JP2000098331, JP7318892 and JP54107698; KR20080012419, KR20070009295, KR20040078446 and KR20030058520; CN101334552, CN101136184, CN101089937, CN1784708, CN1536549 and CN1655018. Each of the above-mentioned Intl. patent application publications and issued patents is incorporated herein by reference for purposes including, but not limited to, indicating the background of the present invention and illustrating the state of the art.

As is described in greater detail below, the present invention intends to provide an integrated and simplified source driver system generating a first control signal, including at least one control command and a data signal combined therewith, to output to a data driver in such a way as to mitigate and overcome the above problem.

### SUMMARY OF THE INVENTION

The primary objective of this invention is to provide an integrated and simplified source driver system generating a first control signal, including at least one control command and a data signal combined therewith, to output to a data driver. Accordingly, the amount of data transmitted in the source driver system can be reduced.

The integrated and simplified source driver system in accordance with an aspect of the present invention includes a scan driver and a data driver. The data driver has a signal controller and a plurality of data driver units each of which has a converter. The converter can convert a first control signal into display data, a driver-unit control signal and a second control signal. The data driver unit can correspondingly send a data drive signal to one of thin film transistors according to the display data and the driver-unit control signal. The second control signal is sent to the scan driver for generating a scan drive signal which is correspondingly sent to one of the thin film transistors.

The integrated and simplified source driver system in accordance with a separate aspect of the present invention includes a scan driver and a data driver. The data driver includes a signal controller and a plurality of data driver units and at least one converter. The converter can convert a first control signal into display data, a driver-unit control signal and a second control signal. The data driver unit can correspondingly send a data drive signal to one of thin film transistors according to the display data and the driver-unit control signal. The second control signal is sent to the scan driver for generating a scan drive signal which is correspondingly sent to one of the thin film transistors.

In a further separate aspect of the present invention, the first control signal includes a drive-unit pulse signal.

In a yet further separate aspect of the present invention, the first control signal includes an integrated drive-unit control command.

Further scope of the applicability of the present invention will become apparent from the detailed description given hereinafter. However, it should be understood that the detailed description and specific examples, while indicating preferred embodiments of the invention, are given by way of illustration only, since various will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic view of a source driver system for displays in accordance with TWN Patent Pub. No. I286299.

FIG. 2 is a schematic block diagram of a scan driver and a data driver provided in a source driver system for displays.

FIG. 3 is a schematic view of a series of waveforms of a first control signal and a second control signal generated from the data driver of the source driver system.

FIG. 4 is a schematic block diagram of a scan driver and a data driver provided in a source driver system for displays in accordance with a preferred embodiment of the present invention.

FIG. 4A is a block diagram of a scan driver unit and a data driver unit provided in the source driver system of FIG. 4 in accordance with a preferred embodiment of the present invention.

FIG. 5 is a series of waveforms of a first control signal and a second control signal generated from the data driver of the source driver system in accordance with a first embodiment of the present invention.

FIG. 6 is a series of waveforms of the first control signal and the second control signal generated from the data driver of the source driver system in accordance with a second embodiment of the present invention.

### DETAILED DESCRIPTION OF THE INVENTION

It is noted that an integrated and simplified source driver system for displays in accordance with the preferred embodiment of the present invention can be applicable to a wide variety of different source driver systems of liquid crystal displays (may be abbreviated as “LCDs”) or the like; and can be implemented on a suitable semiconductor chip or the like which is not limitative of the present invention.

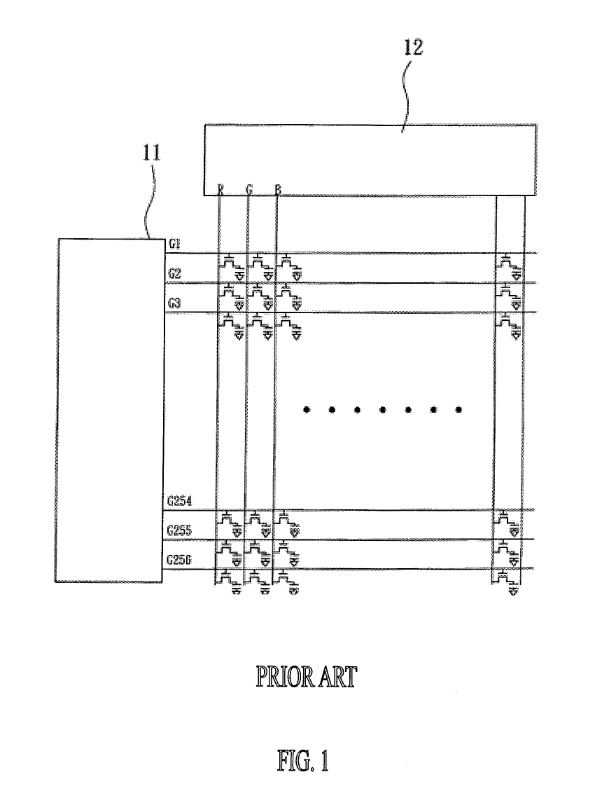

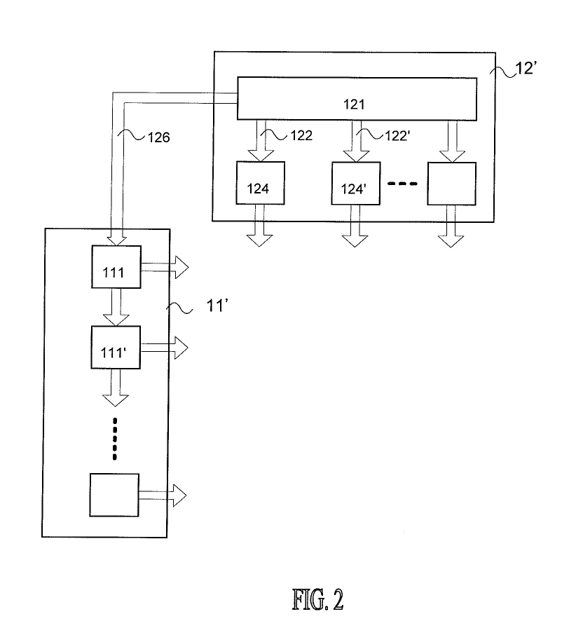

Throughout the specification, similar or identical elements will be given consistent identifying numerals throughout FIGS. 1-2, 4 and 5-6. FIG. 2 illustrates a scan driver and a data driver which may be provided in a source driver system for displays.

Referring to FIG. 2, the data driver 12′ includes a signal controller 121 and a plurality of data driver units 124, 124′. The signal controller 121 is used to receive signals from a computer device or signal source. After receiving the signal, the signal controller 121 is operated to convert an analog signal to a digital signal which is further processed by signal ratio amplification or reduction and timing control. Subsequently, first control signals 122, 122′ are output to the corresponding data driver units 124, 124′. The data driver units 124, 124′ are capable of sending drive signals to a number of the corresponding thin film transistors according to the control signals. Additionally, the signal controller 121 is functioned to output a second control signal 126 to the scan driver 11′.

Still referring to FIG. 2, the scan driver 11′ includes at least one scan driver unit 111 or a plurality of scan driver unit 111, 111′ which are serially connected, wherein the scan driver unit 111 is a first-level scan driver unit, the scan driver unit 111′ is a second-level scan driver unit, and the rest scan driver unit(s) may be deduced by analogy. In operation, the scan driver 11′ is used to receive the second control signal 126 transmitted from the signal controller 121. After receiving the second control signal 126, the scan driver unit 111 of the scan driver 11′ is operated to output a drive signal to the corresponding thin film transistor. Alternatively, the scan driver unit 111 (i.e. first level) is further operated to convey the second control signal 126 to the scan driver unit 111′ (i.e. second level). After receiving the second control signal 126, the scan driver unit 111′ is operated to output a drive signal to the corresponding thin film transistor according to the second control signal 126.

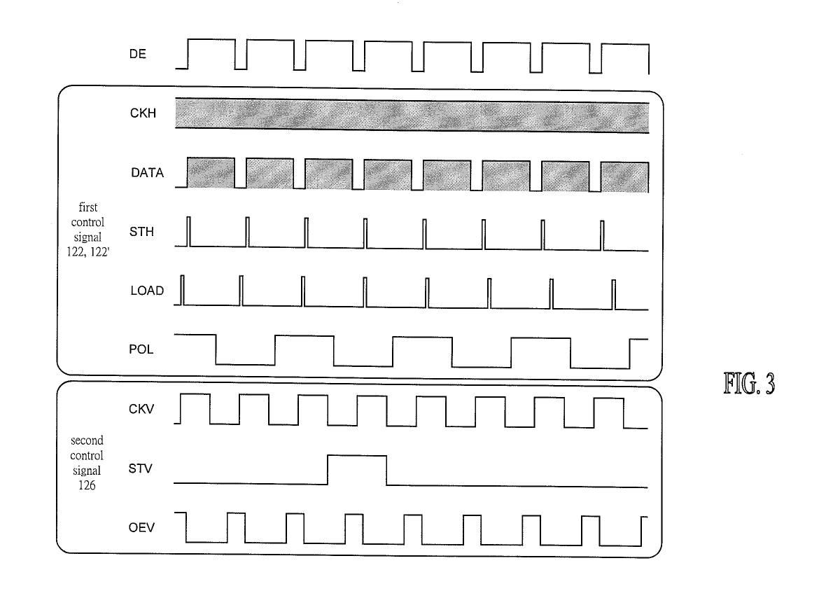

FIG. 3 illustrates a series of waveforms of the first control signal 122, 122′, and the second control signal 126 which may be generated from the data driver 12′. Referring now to FIGS. 2 and 3, the signal controller 121 connects with the data driver units 124, 124′ for transmitting the first control signals 122, 122′, including CKH signal, DATA signal, STH signal, LOAD signal, and POL signal, wherein CKH signal will be known as a pulse signal for the data driver 12′, DATA signal will be known as a data display signal for the data driver 12′, STH signal will be known as a start signal for the data driver 12′, LOAD signal will be known as a data-loading signal for the data driver 12′, and POL signal will be known as a polarity reversal signal for the data driver 12′.

With continued reference to FIGS. 2 and 3, the signal controller 121 connects with the scan driver unit 111 for transmitting the second control signal 126, including CKV signal, STV signal, and OEV signal, wherein CKV signal will be known as a pulse signal for the scan driver 11′, STV signal will be known as a start signal for the scan driver 11′, and OEV signal will be known as an output start signal of the scan driver 11′.

It is apparent from FIG. 2 that the signal controller 121 of the data driver 12′ require transmitting the display data and control signal to the different scan driver units 111, 111′ of the scan driver 11′ such that the integrated and simplified source driver system in accordance with the preferred embodiment of the present invention is provided.

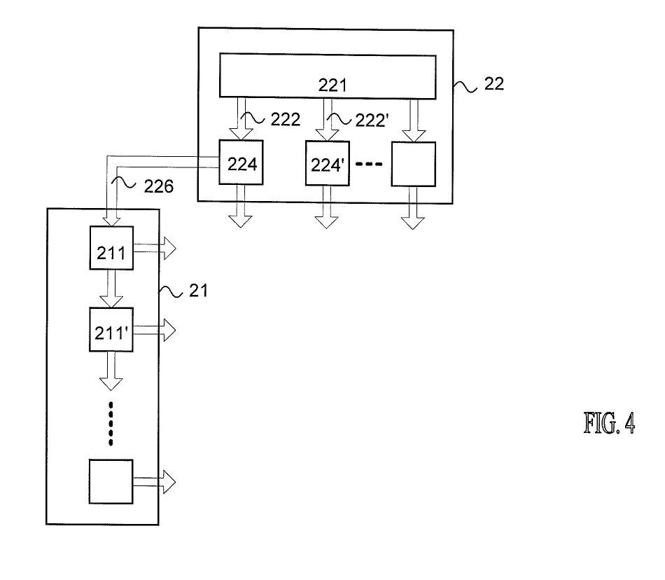

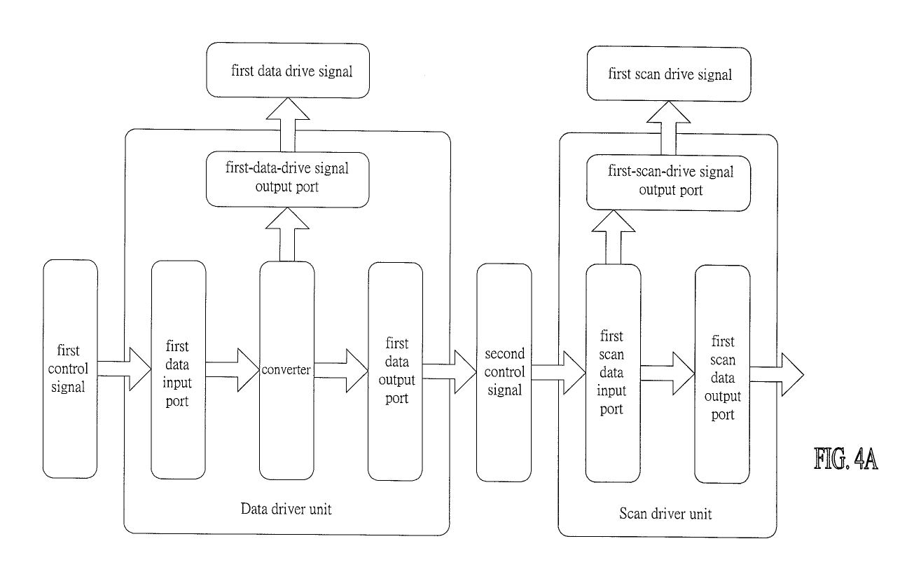

FIG. 4 illustrates a scan driver and a data driver provided in the integrated and simplified source driver system in accordance with the preferred embodiment of the present invention. Referring to FIG. 4, the source driver system includes a scan driver 21 and a data driver 22. The scan driver 21 includes at least one scan driver unit 211 or a plurality of scan driver unit 211, 211′ which are serially connected, wherein the scan driver unit 211 is a first-level scan driver unit, the scan driver unit 211′ is a second-level scan driver unit, and the rest scan driver unit(s) may be deduced by analogy to form the multiple levels of the scan driver units.

Still referring to FIG. 4, the data driver 22 includes a signal controller 221 and a plurality of data driver units 224, 224′ connected with the signal controller 221. The signal controller 221 is used to receive signals from a computer device or signal source. After receiving the signal, the signal controller 221 is operated to convert an analog signal to a digital signal which is further processed by signal ratio amplification or reduction and timing control. Subsequently, first control signals 222, 222′ are output to the corresponding data driver units 224, 224′.

FIG. 4A illustrates a scan driver unit and a data driver unit provided in the source driver system, as shown in FIG. 4. Each of the data driver units 224, 224′ includes a converter which is capable of converting the first control signals 222, 222′ into a display data, a driver-unit control signal and a second control signal 226. The data driver units 224, 224′ can correspondingly send a data drive signal (i.e. first data drive signal) to one of the thin film transistors (as best shown in the middle portion of FIG. 1) according to the display data and the driver-unit control signal. For example, the data drive signals are output from the data driver units 224, 224′ via a first-data-drive-signal output port, as shown in FIG. 4A. Furthermore, the second control signal 226 is sent to the scan driver 21 from the data driver unit 224, as discussed in detail below, or any of a number of the data driver units.

Referring again to FIGS. 4 and 4A, when the second control signal 226 is received, the scan driver unit 211 of the scan driver 21 can correspondingly send a scan drive signal (i.e. first scan drive signal) to one of the thin film transistors (as best shown in the middle portion of FIG. 1) according to the second control signal 226. For example, the scan drive signal is output from the scan driver unit 211 via a first-scan-drive-signal output port, as shown in FIG. 4A. Furthermore, the scan driver unit 211 (i.e. first level) is further operated to convey the second control signal 226 to the next-level scan driver unit 211′ (i.e. second level). After receiving the second control signal 226, the scan driver unit 211′ is operated to output a second scan drive signal to the corresponding thin film transistor according to the second control signal 226.

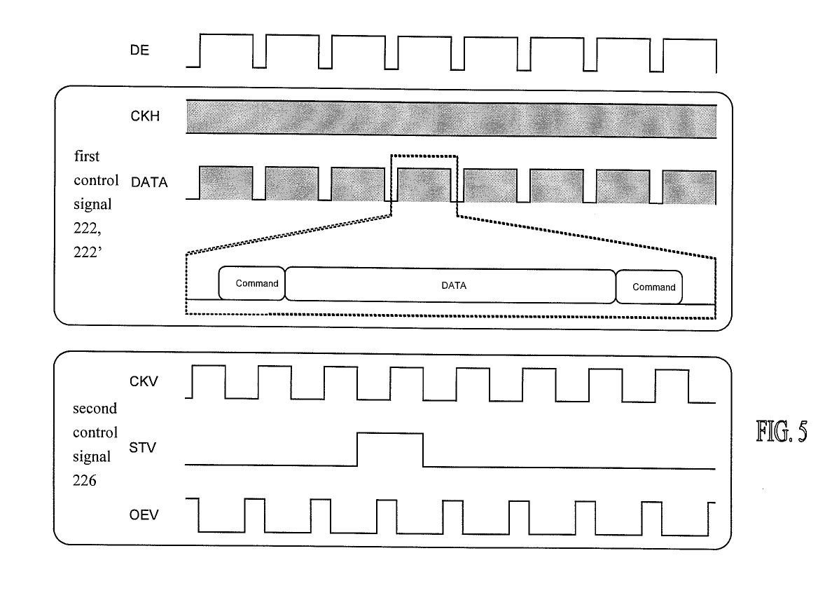

FIG. 5 illustrates a series of waveforms of the first control signal 222, 222′ and the second control signal 226 generated from the data driver 22, as best shown in FIG. 4, of the source driver system in accordance with a first embodiment of the present invention. Referring now to FIGS. 4 and 5, in the first embodiment the signal controller 221 of the data driver 22 is operated to send the first control signals 222, 222′, advantageously including CKH signal and DATA signal, to the corresponding data driver units 224, 224′; wherein CKH signal is a pulse signal (e.g. drive-unit pulse signal) for the data driver 22, and DATA signal of the data driver 22 comprises a display data and a control command (i.e. an integrated drive-unit control command), as best shown in dotted line in FIG. 5.

Still referring to FIGS. 4 and 5, in the first embodiment the signal controller 221 of the data driver 22 is further operated to send the second control signal 226, including CKV signal, STV signal and OEV signal, to the scan driver 21; wherein CKV signal is a pulse signal for the scan driver 21, STV signal is a start signal for the scan driver 21, and OEV signal is an output start signal of the scan driver 21.

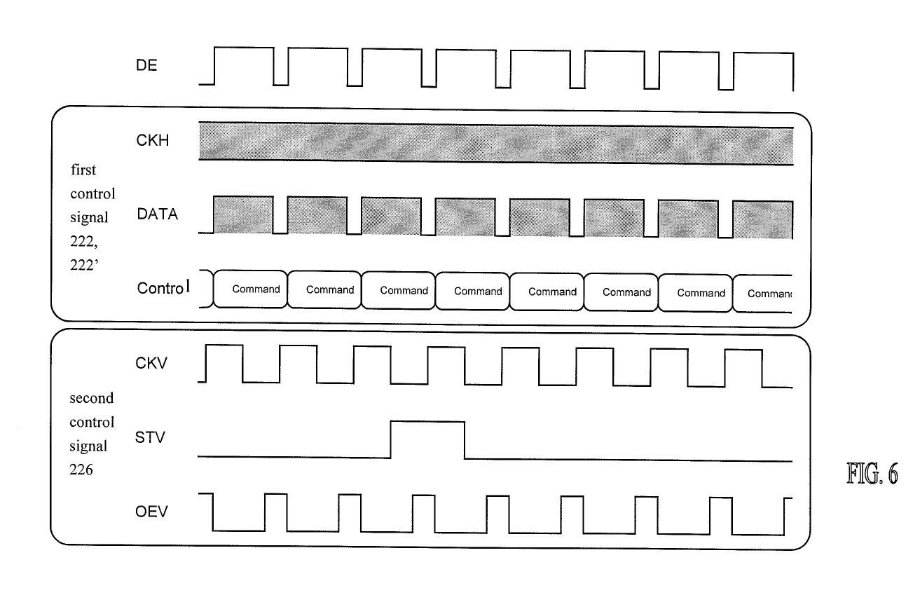

FIG. 6 illustrates a series of waveforms of the first control signal 222, 222′ and the second control signal 226 generated from the data driver 22, as best shown in FIG. 4, of the source driver system in accordance with a second embodiment of the present invention. Referring now to FIGS. 4 and 6, in the second embodiment the signal controller 221 of the data driver 22 is operated to send the first control signals 222, 222′, advantageously including CKH signal, DATA signal and Control signal, to the corresponding data driver units 224, 224′; wherein CKH signal is a pulse signal for the data driver 22, and DATA signal is a display data for the data driver 22, and Control signal is an integrated drive-unit control command. However, the use of the integrated drive-unit control command can take advantage of the reduced amount of data transmitted in the source driver system of the present invention.

Still referring to FIGS. 4 and 6, in the second embodiment the signal controller 221 of the data driver 22 is further operated to send the second control signal 226, including CKV signal, STV signal and OEV signal, to the scan driver 21; wherein CKV signal is a pulse signal for the scan driver 21, STV signal is a start signal for the scan driver 21, and OEV signal is an output start signal of the scan driver 21.

Although the invention has been described in detail with reference to its presently preferred embodiment, it will be understood by one of ordinary skill in the art that various modifications can be made without departing from the spirit and the scope of the invention, as set forth in the appended claims.

What is claimed is:

1. An integrated and simplified source driver system for displays, comprising:
a scan driver; and
a data driver having a signal controller and a plurality of data driver units each of which including a converter, the converter converting a first control signal into display data, a driver-unit control signal and a second control signal;
wherein the data driver unit can correspondingly send a data drive signal to one of thin film transistors according to the display data and the driver-unit control signal; and
wherein the second control signal is sent to the scan driver for generating a scan drive signal which is correspondingly sent to one of the thin film transistors.

2. The source driver system as defined in claim 1, wherein the first control signal includes a drive-unit pulse signal and a data signal which comprises a display data and a control command.

3. The source driver system as defined in claim 1, wherein the first control signal includes a drive-unit pulse signal, a data signal and a control command.

4. An integrated and simplified source driver system for displays, comprising:
a scan driver; and
a data driver having a signal controller and a plurality of data driver units and a converter, the converter converting a first control signal into display data, a driver-unit control signal and a second control signal;
wherein the data driver unit can correspondingly send a data drive signal to one of thin film transistors according to the display data and the driver-unit control signal; and
wherein the second control signal is sent to the scan driver for generating a scan drive signal which is correspondingly sent to one of the thin film transistors.

5. The source driver system as defined in claim 4, wherein the first control signal includes a drive-unit pulse signal and a data signal which comprises a display data and a control command.

6. The source driver system as defined in claim 4, wherein the first control signal includes a drive-unit pulse signal, a data signal and a control command.

7. An integrated and simplified source driver system for displays, comprising:
a first control signal generated from a source, the first control signal comprising at least one control command and a data signal to a data driver; and
a second control signal generated from the data driver to send to a scan driver.

8. The source driver system as defined in claim 7, wherein the first control signal includes a drive-unit pulse signal.

9. The source driver system as defined in claim 7, wherein the control command is an integrated drive-unit control command.
